(19) United States
(12) Patent Application Publication
(10) Pub. No.: US 2006/0124323 A1
(43) Pub. Date: Jun. 15, 2006

(54) Work linkage position determining system

(75) Inventors: Clarence Matthew Glover, Washington, IL (US); Clayton Lucas Padgett, Raleigh, NC (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Caterpillar Inc.

(21) Appl. No.: 10/998,737

(22) Filed: Nov. 30, 2004

(51) Int. Cl. A01B 41/06

(52) U.S. Cl. 172/2

(57) ABSTRACT

A position determining system for a work machine includes a body and a work linkage. A laser receiver may be configured to detect a laser beam and communicate a height signal indicative of the height of the work machine body relative to the laser beam. A swing frame may pivot in a lateral direction relative to the work machine body about a swing axis and may include a swing frame sensor configured to monitor the swing position. A portion of a digging arm may pivot in the lateral direction about the swing axis and may include at least one digging arm sensor configured to monitor the position of the digging arm. A control module may be in communication with the laser receiver, the swing frame sensor, and the digging arm sensor. The control module may be configured to determine a position of the work linkage relative to the desired grade.

### TECHNICAL FIELD

This disclosure is directed to a system and method for determining a position of a work linkage, and more particularly, to a system and method for determining a position of a work linkage relative to a laser beam.

### BACKGROUND

Worksite preparations often include grading a worksite to form a specific, desired slope. Conventional grading may require that multiple grading stakes be placed about the worksite as reference points to ensure that the correct amount of material is removed or added to form the desired grade. The accuracy of the grade slope, however, may be dependent upon the number of grade stakes used and the distance between each grade stake. As the distance between stakes increases, the error in the grade slope may also increase. Accordingly, to minimize error in the grade slope, surveyors place stakes a limited distance apart. Depending on the worksite, stake placement may be a lengthy and tedious process. Further, during the actual grading, additional personnel often are needed to monitor the grade to ensure that the grade is within acceptable limits.

Additional difficulties arise when trenching with a digging linkage, such as is found on a backhoe or excavator. Trenching often requires that the work machine be repositioned several times during a single excavation. Each time that the work machine is repositioned, it may be positioned relative to the prior position. Accordingly, each time it is repositioned, there is an opportunity to introduce error in the trench grade, and further, the error may be compounded with each repositioning.

One known system for increasing accuracy of the grade slope without increasing the number of grade stakes uses a laser plane as a reference point, instead of the grade stakes. The laser plane may be emitted over the worksite so that it is parallel to the desired grade. During grading, a work machine may reference the laser plane while excavating the ground or earth in order to create the desired grade.

One laser system is disclosed in U.S. Pat. No. 6,263,595 to Ake. The '595 patent discloses an excavator including a laser receiver mounted to an electric mast. Rotation sensors are mounted to the pivot joints between the platform and boom, the boom and dipperstick, and the dipperstick and bucket, so as to provide a complete solution in detecting the digging level with respect to a laser plane of light. However, the '595 patent does not disclose a system that considers the lateral swing of a work linkage relative to the body of the work machine. Therefore, the system disclosed in the '595 patent may not provide accuracy when used in an environment where a work linkage moves laterally with respect to the work machine body.

The systems and methods for determining a position of a work linkage disclosed herein overcome one or more of the shortcomings of conventional systems.

### SUMMARY OF THE INVENTION

In one exemplary aspect, a position determining system for a work machine having a body and a work linkage is disclosed. The position determining system may be usable with a laser beam generator configured to generate a laser beam indicative of a desired grade. The position determining system may include a laser receiver disposed on the work machine body and configured to detect the laser beam. The laser receiver may be configured to communicate a height signal indicative of the height of the work machine body relative to the laser beam. A work linkage may be supported by and extend from the work machine body. The work linkage may include a swing frame configured to pivot in a lateral direction relative to the work machine body about a swing axis and may also include a swing frame sensor configured to monitor the swing position of the swing frame. The work linkage may further include a digging arm associated with the swing frame. At least a portion of the digging arm may be configured to pivot in the lateral direction about the swing axis. At least one digging arm sensor may be associated with the digging arm and may be configured to monitor the position of the digging arm. A control module may be in communication with the laser receiver, the swing frame sensor, and the digging arm sensor. The control module may be configured to determine a position of a portion of the work linkage relative to the desired grade.

In another exemplary aspect, a method for determining the position of a work implement on a work machine relative to a desired grade defined by a laser beam is disclosed. The work machine may have a body and a work linkage. The method may include detecting the laser beam at a laser receiver and communicating a height signal based on the laser beam from the laser receiver. The height signal may be indicative of a position of the work machine body relative to the laser beam. A swing frame of the work linkage may be pivoted in a lateral direction relative to the work machine body about a swing axis. The swing position of the swing frame may be monitored and a signal indicative of the position of the swing frame may be communicated. The method may also include monitoring a position of a digging arm of the work linkage with at least one digging arm sensor. A signal indicative of the position of the digging arm may be communicated. Finally, the method may include determining a position of a portion of the work linkage relative to the desired grade.

### BRIEF DESCRIPTION OF THE DRAWINGS

FIG. 1 is a diagrammatic side view of an exemplary embodiment of a backhoe loader.

FIG. 2 is a block diagram of an exemplary control system.

FIG. 3 is a flow chart showing an exemplary method of monitoring a position of a work linkage of a backhoe loader.

### DETAILED DESCRIPTION

Reference will now be made in detail to exemplary embodiments, examples of which are illustrated in the accompanying drawings. Wherever possible, the same reference numbers will be used throughout the drawings to refer to the same or like parts.

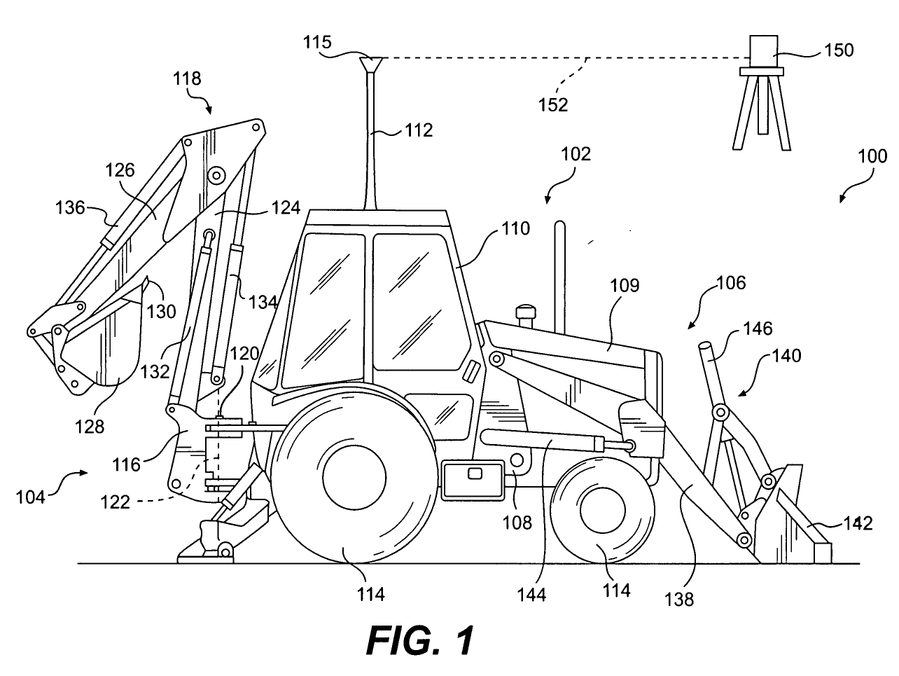

An exemplary embodiment of a backhoe loader 100 is illustrated in FIG. 1. The backhoe loader 100 includes a body 102, a rear work linkage 104, and a front work linkage 106. The body 102 includes a frame structure 108, an engine compartment 109, an operator's station 110, and a laser mast 112. Wheels 114 support the body 102 and may be used to propel the backhoe loader 100 over the ground. Although the backhoe loader 100 is disclosed with wheels 114, it may instead include a track or other supporting and propelling system.

The engine compartment 109 may house an engine (not shown) and other components for operating and powering the backhoe loader 100. The engine may drive the wheels 114 to move the loader and, in addition, may provide power to operate the rear and front work linkages 104, 106.

The operator's station 110 may be supported on the frame structure 108 and may be open or an enclosed compartment. Controls may be associated with the operator's station 110 and may include, for example, one or more input devices for operating and/or driving the backhoe loader 100. In one exemplary embodiment, the controls may also include one or more displays for conveying information to an operator.

The laser mast 112 may extend upward from the body 102 of the backhoe loader 100. In this embodiment, the laser mast 112 extends upwardly from the top of the operator's station 110. However, the laser mast 112 may extend upwardly from any position that is fixed relative to the body 102, including, for example, from the engine compartment 109 or the frame structure 108. In one exemplary embodiment, the laser mast 112 extends upwardly from a location at one side of the engine compartment 109, and in another, from a location on the frame structure 108 disposed behind the operator's station 110, adjacent the rear work linkage 104.

The laser mast 112 may include a laser receiver 115 disposed thereon. The laser receiver 115 may include a plurality of linearly aligned photo receptors and associated circuitry (not shown) for delivering an output signal representative of the particular receptor illuminated. The laser mast 112 may be configured to extend and retract to change the height of the laser receiver 115 to track a laser beam and/or a laser plane that may be defined by the beam. Accordingly, as the backhoe loader 100 moves across the worksite, the laser mast 112 may maintain the laser receiver 115 in line with the laser beam despite elevational changes of the backhoe loader 100. By detecting the laser beam, the laser receiver 115 may be configured to monitor the height of the backhoe loader 100 relative to the laser beam. Based upon the sensed laser beam, the laser receiver 115 may also be configured to communicate a height signal indicative of the height of the backhoe loader 100.

The rear work linkage 104 may connect to and be supported by the body 102. The rear work linkage 104 may be used, for example, to dig a hole or ditch, level the ground, or grade an area at a desired slope. The rear work linkage 104 may include a swing frame 116 and a digging arm 118. The swing frame 116 may connect to the body 102 through a pin connection 120 and may laterally pivot relative to the body 102 about a swing axis 122, defined by the pin connection 120. When the swing frame 116 laterally rotates, the digging arm 118 swings in a lateral direction, about the swing axis 122. In one embodiment, the swing axis 122 is substantially vertical relative to the body 102 of the backhoe loader 100. In the exemplary embodiment shown, the swing frame 116 directly attaches to the body 102. However, the swing frame 116 may be connected between components of the digging arm 118 or otherwise disposed.

The digging arm 118 includes a boom member 124, a stick member 126, and a work implement 128. The boom member 124 may be connected to the swing frame 116 and may extend between the swing frame 116 and the stick member 126. In one exemplary embodiment, the boom member 124 is configured to pivot relative to the body 102, and therefore, is both the boom member 124 and the swing frame 116. The stick member 126 may extend from the boom member 124 to the work implement 128, and the work implement 128 may be connected to an end of the stick member 126. In one exemplary embodiment, the stick member 126 may be an extendable stick. The extendable stick may be comprised of an inner and an outer member movable relative to one another.

The work implement 128 may be, for example, a bucket or shovel for picking up and moving dirt and soil, but may be any other implement, as would be apparent to one skilled in the relevant art. For example, the work implement 128 of the digging arm 118 may include a bucket, a drilling implement, a cutting implement, or other implement known in the art. In the embodiment shown, the work implement 128 is a bucket having a work implement tip 130, which may be formed of a tooth or leading edge.

A boom actuator 132, a stick actuator 134, a rear work implement actuator 136, and a swing frame actuator (not shown) may be associated with the rear work linkage 104 to manipulate and operate the rear work linkage 104 to perform any of a variety of tasks in a manner known in the art. The actuators 132, 134, 136 may be hydraulic powered cylinders, but also may be other types of actuators as would be apparent to one skilled in the art. In the exemplary embodiment employing an extendable stick, an additional actuator may extend and retract the inner member relative to the outer member.

The front work linkage 106 may connect to and be supported by the body 102. Extending from the front of the body 102 of the backhoe loader 100, the front work linkage 106 may include a loader boom 138, a tilt mechanism 140, and a loader bucket 142. In addition, the front work linkage 106 may include a lift actuator 144 and a tilt actuator 146 for raising the loader boom 138 and tilting the loader bucket 142.

A laser generator 150 may be configured to deliver a low intensity laser beam 152 that may be swept about to define a laser plane (not shown). The laser generator 150 may be positioned at a preselected coordinate location (“x”, “y”) within a surveyed area, such as the worksite. The laser beam 152 may define the laser plane as a plane above the worksite at a predetermined elevational position, with the laser plane being substantially parallel to a desired worksite grade. The distance between the laser plane and the desired grade may thereby establish an elevational coordinate position “z”.

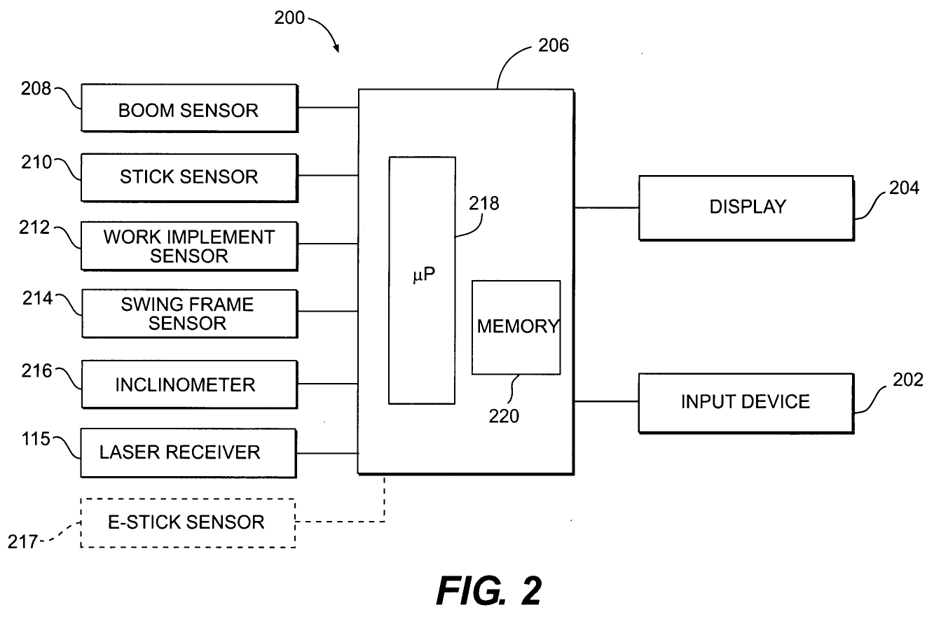

FIG. 2 shows an exemplary control system 200 for determining the position of the work implement 128 relative to the generated laser beam, such as a laser plane. As described in greater detail below, the control system 200 may be configured to determine the position of a portion of the rear work linkage 104, such as the work implement tip 130, relative to the desired grade. It should be noted that although this description describes determining the position of the work implement tip 130, the control system 200 may be used to determine the position of any portion of the digging arm 118 relative to the desired grade and/or laser beam.

The control system 200 may include an input device 202, a display 204, a control module 206, the laser receiver 115, and one or more sensors that provide measured inputs. In one exemplary embodiment, the sensors may include a boom sensor 208, a stick sensor 210, a work implement sensor 212, a swing frame sensor 214, and an inclinometer 216. If the stick member 126 is an extendable stick, an E-stick sensor 217 may be used to monitor the extension of the extendable stick. Using information gathered by one or more of the sensors, the control system 200 may calculate the position of the work implement tip 130 relative to the desired grade.

The input device 202 could be one or more joysticks, keyboards, levers, or other input devices known in the art. Adapted to generate a desired movement signal, the input device 202 may receive an input from an operator and communicate the input as an input signal to the control module 206. The input device 202 may be used to operate or drive the backhoe loader 100 and may also be used to control the swing frame 116 and the components of the digging arm 118.

The control module 206 may include a processor 218 and a memory device 220. The memory device 220 may store one or more control routines, which could be software programs, for determining a position of the work implement tip 130 relative to the laser beam and/or the desired grade. The processor 218 may receive the input signal from the input device 202 and may execute the routines to generate and deliver a command signal to control the swing frame 116 and the components of the digging arm 118.

The boom sensor 208 may be associated with the boom 124 in a manner to monitor the position of the boom 124 relative to the swing frame 116. The stick sensor 210 may be associated with the stick in a manner to monitor the position of the stick 126 relative to the boom 124. The work implement sensor 212 may be associated with the work implement 128 in a manner to monitor the position of the work implement 128 relative to the stick 126. And when the stick member 126 is an extendable stick, the E-stick sensor 217 may be associated with the extendable stick to monitor the extension of the inner member relative to the outer member.

In one exemplary embodiment, the boom, stick, and work implement sensors 208, 210, 212 are position sensors, such as in-cylinder position sensors, configured to measure an extension amount of the respective boom, stick, and work implement actuators 132, 134, 136. In another exemplary embodiment, the boom, stick, and work implement sensors 208, 210, 212 are rotary sensors associated with the respective boom, stick, and work implement actuators 132, 134, 136. When the stick member 126 is an extendable stick, the E-stick sensor 217 may also be a position sensor, such as an in-cylinder position sensor. The boom, stick, and work implement sensors 208, 210, 212, as well as the optional E-stick sensor 217, may be in communication with the control module 206 and may provide signals to the control module 206 indicative of the sensed parameter.

The swing frame sensor 214 may be associated with the swing frame 116 in a manner to monitor the position of the swing frame 116 relative to the body 102 of the backhoe loader 100. As used herein, the position of the swing frame 116 relative to the backhoe loader body 102 is referred to as a swing position. In one exemplary embodiment, the swing frame sensor 214 is a solid-state rotary sensor that monitors the pivot of the swing frame 116 relative to the frame structure 108. In another exemplary embodiment, the swing frame sensor 214 is a position senor, such as an in-cylinder position sensor, configured to measure an extension amount of the swing frame actuators (not shown).

Based upon the signals from one or more of the sensors 208, 210, 212, 214, the control module 206 may be configured to use trigonometric and/or kinematic equations to determine the position of the work implement tip 130 relative to the body 102 of the backhoe loader 100. It should be noted that the control module 206 may monitor one or more of the sensors 208, 210, 212, 214, 217 at a single time, but does not need to monitor them all at the same time.

The inclinometer 216 may be associated with the backhoe loader 100 and may be configured to monitor and determine inclination of the backhoe loader 100, in any direction, including the pitch and roll directions. The pitch may be the front to back rotation and the roll may be the side to side rotation. In one embodiment, the inclinometer 216 is disposed on the frame structure 108. It should be noted, however, the inclinometer 216 may be disposed on the backhoe loader 100 at any location that may be representative of the tilt or roll of the backhoe loader 100 and/or the work implement 128.

The laser receiver 115 may be associated with the control module 206 and may be configured to monitor the height of the body 102 of the backhoe loader 100 relative to the laser beam. The laser receiver 115 may also be configured to communicate a height signal indicative of the height to the control module 206.

The control module 206 may use the information received from the boom, stick, work implement, and swing frame sensors 208, 210, 212, 214, the inclinometer 216, and the laser receiver 115 to determine the position of the work implement tip 130 relative to the laser beam and/or the desired grade. When appropriate, the control module 206 may also consider information from the E-stick sensor 217.

Based upon the signals from the sensors 208, 210, 212, 214, 217 the control module 206 may be configured to use trigonometric and/or kinematic equations to determine the position of the work implement tip 130 relative to the body 102 of the backhoe loader 100. In addition, based upon the signals from the inclinometer 216, and the laser receiver 115, the control module 206 may be configured to determine the position of the body 102 relative to the laser beam. Finally, based on the position of the work implement tip 130 relative to the body 102, the position of the body 102 relative to the laser beam 152, and the position of the laser beam 152 relative to the desired grade, the control module 206 may determine the position of the work implement tip 130 relative to the desired grade.

The display 204 may also be associated with the control module 206 and may be configured to present information for viewing by the operator. In one embodiment, the display 204 may be positioned on the backhoe loader 100 for viewing from the operator's station 110. Therefore, the operator may view the display 204 while operating the backhoe loader 100. In one exemplary embodiment, the information is sent to the display 204 as a display signal from the control module 206. The display signal may include information indicative of the position of the work implement tip 130 relative to the desired grade. Accordingly, while operating the backhoe loader 100, an operator may view the display 204 and have an indication of the position of the work implement tip 130 relative to the desired grade and/or the backhoe loader 100.

In one exemplary embodiment, the display 204 shows the position of the work implement tip 130 in an x, y, z coordinate system. In another exemplary embodiment, the display 204 includes a series of LED lights that indicate whether the work implement tip 130 is above grade, on grade, or below grade. In one exemplary embodiment, instead of, or in addition to, a visual display, the control module 206 is associated with an audible display indicator configured to indicate whether the work implement tip 130 is above grade, on grade, or below grade.

In one exemplary embodiment, the control module 206 may be configured to provide a virtual floor and/or a virtual ceiling corresponding to the desired grade. Accordingly, when the virtual floor is implemented, the control module 206 may be configured to restrict movement of the work implement 128 and/or any points on the rear linkage 128 to positions that are above the desired grade. Similarly, when the virtual ceiling is implemented, the control module 206 may be configured to restrict movement of the work implement 128 and/or any points on the rear linkage 128 to positions that are below the established virtual ceiling.

### INDUSTRIAL APPLICABILITY

The control system 200 described herein may simplify the process of grading a worksite or trenching at a grade with a work machine, such as the backhoe loader 100. Backhoe loaders are widely used service machines that may accomplish any number of tasks, including digging along a grade. Use of the control system 200 may ease the task of grading by allowing the work machine operator to know when the work machine is on grade. This may reduce the reliance on external personnel, such as surveyors who may otherwise be required to monitor grading and/or digging progress to ensure that the grade is within acceptable limits. Furthermore, because the system relies upon a laser as a reference point, it may reduce or eliminate the need for grade stakes, yet may still provide a more accurate system than can be achieved with grade stakes because the laser is equivalent to an infinite number of reference points.

The control system 200 may be capable of determining the location of the tip 130 of the work implement 128 relative to a desired grade. The desired grade may be defined by a laser beam 152 generated above the worksite. In one embodiment, the laser beam is a laser plane established to be substantially parallel to the desired grade, but offset from the desired grade by a known height.

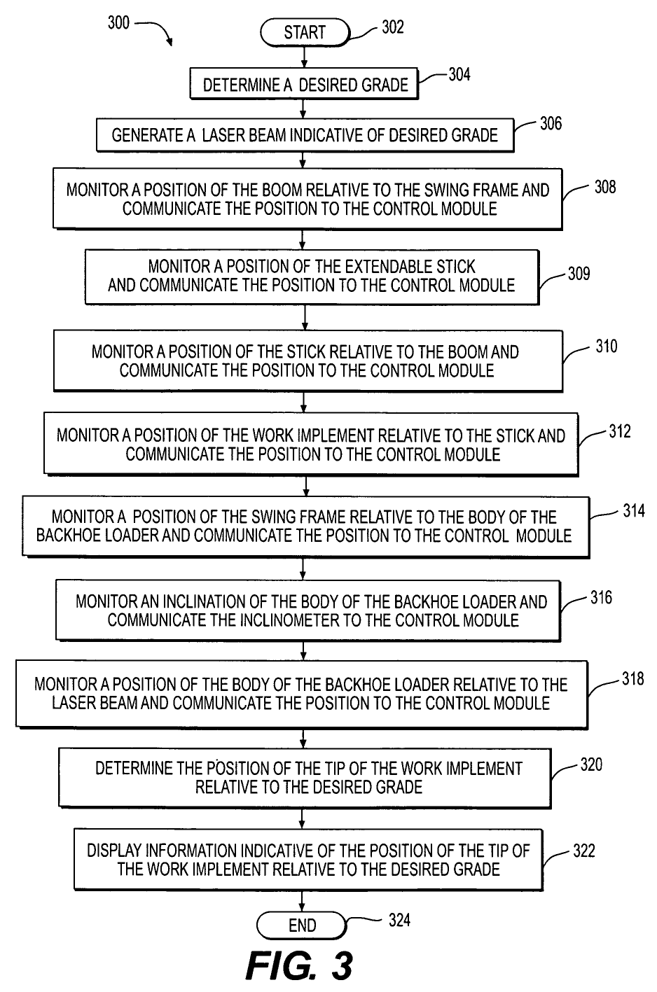

FIG. 3 shows an exemplary method 300 of grading a worksite or trenching along a grade with the backhoe loader 100. The method begins at a start step 302. At a step 304, a desired grade is determined. The desired grade may be worksite specific and may be called out on blueprints. At a step 306, a laser beam 152 is generated over the worksite that is indicative of the desired grade. Generated by the laser beam generator 150, the laser beam 152 may be emitted substantially parallel to, and at a known height above, the desired grade. Therefore, the laser beam 152 may be used as a reference to define the height of the backhoe loader 100 relative to the desired grade.

At a step 308, the boom sensor 208 monitors the position of the boom 124 relative to the swing frame 116 and communicates a signal indicative of the boom position to the control module 206. At a step 309, and when the backhoe loader 100 includes the optional extendable stick, the E-stick sensor 217 may monitor the position of one member of the extendable stick relative to the other, and communicate the position to the control module 206. At a step 310, the stick sensor 210 monitors the position of the stick 126 relative to the boom 124 and communicates a signal indicative of the stick position to the control module 206. At a step 312, the work implement sensor 212 monitors the position of the work implement 128 relative to the stick 126 and communicates a signal indicative of the work implement position to the control module 206. At a step 314, the swing frame sensor 214 monitors the position of the swing frame 116 relative to the body 102 of the backhoe loader 100. The swing frame sensor 214 may communicate a signal indicative of the swing frame position, or swing position, to the control module 206. The control module 206 may consider the signals representative of the positions of the boom 124, the stick 126, the work implement 128, and the swing frame 116 to determine the position of the work implement tip 130 relative to the body 102 of the backhoe loader 100.

At a step 316, an inclination of the backhoe loader 100 is monitored with the inclinometer 216. The inclinometer 216 may communicate an incline signal indicative of the inclined position to the control module 206. The incline signal is indicative of the pitch or roll of the backhoe loader 100 and may allow for compensation in determining the position of the body 102 backhoe loader 100 relative to the laser beam.

At a step 318, the position of the body 102 relative to the laser beam 152 is monitored by the laser receiver 115. As stated above, the laser receiver 115 is attached to the body 102 and may be disposed on the laser mast 112. A height signal, indicative of the position of the body 102 relative to the laser beam, may be communicated from the laser receiver 115 to the control module 206.

The control module 206 may receive the height signal, the signals representative of the positions of the swing frame 116, the boom 124, the stick 126 (which may be the extendable stick), the work implement 128, and the incline signal. As stated above, the laser beam 152 is indicative of the desired grade, and the height signal is indicative of the height of the body 102 relative to the laser beam 152. In addition, the signals representative of the positions of the swing frame 116, the boom 124, the stick 126, and the work implement 128 may be used to determine the position of the work implement tip 130 relative to the body 102. Finally, the incline signal allows compensation for pitch or roll of the backhoe loader 100. Based upon one or more of these signals, and using stored trigonometric and/or kinematic equations or processes, the control module 206 may determine the position of the work implement tip 130 relative to the desired grade, at a step 320.

At a step 322, the control module 206 may also generate and communicate a display signal to the display 204. The display signal may include information indicative of the position of the work implement tip 130 relative to the desired grade. The method ends at a step 324.

The system and method described herein allows an operator to continually monitor the position of the tip of the work implement 128 relative to the desired grade. Accordingly, the operator may more closely follow the desired grade as he or she operates the rear work linkage 104 to dig, grade, or trench. In addition, because the operator can monitor the position of the work implement tip 130 relative to the desired grade, reliance on external personnel, such as surveyors, may be reduced, saving costs. Therefore, the present system and method may result in a more accurate grade while reducing the time and manpower required to monitor the grade.

In addition, when trenching, which may require that the backhoe loader be incrementally re-positioned during the process, the desired grade may be monitored relative to a single laser beam. Therefore, if the elevation of the body 102 changes during repositioning, the operator may still grade at the desired grade. In addition, because there is a single laser beam, the entire trench or grade may have only one point of potential error instead of the many points of error that may be introduced when using multiple grade stakes or when repositioning relative to a prior position.

It will be apparent to those skilled in the art that various modifications and variations can be made in the disclosed embodiments without departing from the scope of the invention. Other embodiments of the invention will be apparent to those skilled in the art from consideration of the specification and practice of the invention disclosed herein. It is intended that the specification and examples be considered as exemplary only, with a true scope of the invention being indicated by the following claims and their equivalents.

What is claimed is:

1. A position determining system for a work machine having a body and a work linkage, the position determining system being usable with a laser beam generator configured to generate a laser beam indicative of a desired grade, comprising:
a laser receiver disposed on the work machine body and configured to detect the laser beam, the laser receiver being configured to communicate a height signal indicative of the height of the work machine body relative to the laser beam;
a work linkage supported by and extending from the work machine body, the work linkage including
a swing frame configured to pivot in a lateral direction relative to the work machine body about a swing axis,
a swing frame sensor configured to monitor the swing position of the swing frame,
a digging arm associated with the swing frame, at least a portion of the digging arm being configured to pivot in the lateral direction about the swing axis, and
at least one digging arm sensor associated with the digging arm, the at least one digging arm sensor being configured to monitor the position of the digging arm; and
a control module in communication with the laser receiver, the swing frame sensor, and the at least one digging arm sensor, the control module being configured to determine a position of a portion of the work linkage relative to the desired grade.

2. The position determining system of claim 1, including an inclinometer disposed on the work machine to monitor the pitch and the roll of the work machine body, wherein the control module is configured to determine the position of a portion of the work linkage relative to the desired grade based on the monitored pitch and roll.

3. The position determining system of claim 1, including a swing frame actuator configured to pivot the swing frame and the digging arm about the swing axis.

4. The position determining system of claim 1, including a display associated with the control module and configured to convey information regarding the position of the portion of the work linkage relative to the desired grade to an operator.

5. The position determining system of claim 4, wherein the display includes a series of lights indicating whether the work linkage is above or below the desired grade.

6. The position determining system of claim 1, including an audible indicator configured to indicate whether the work linkage location relative to the desired grade.

7. The position determining system of claim 1, wherein the digging arm includes a work implement having a work implement tip, wherein the control module is configured to determine a position of the work implement tip relative to the desired grade.

8. The position determining system of claim 1, wherein the digging arm includes:
a boom connected to the swing frame;
a stick connected to the boom; and
a work implement connected to the stick.

9. The position determining system of claim 8, wherein the at least one digging arm sensor includes:
a boom sensor associated with the boom and configured to monitor a position of the boom;
a stick sensor associated with the stick and configured to monitor a position of the stick; and
a work implement sensor associated with the work implement and configured to monitor a position of the work implement.

10. The position determining system of claim 8, wherein the boom, stick, and work implement sensors are position sensors associated with actuators configured to actuate the boom, stick, and work implement.

11. The position determining system of claim 10, wherein the position sensors are in-cylinder position sensors.

12. The position determining system of claim 8, wherein the stick is an extendable stick.

13. The position determining system of claim 12, wherein the at least one digging arm sensor includes:
a boom sensor associated with the boom and configured to monitor a position of the boom;
a stick sensor associated with the stick and configured to monitor a position of the stick;
an E-stick sensor associated with the extendable stick and configured to monitor an extension of the extendable stick; and
a work implement sensor associated with the work implement and configured to monitor a position of the work implement.

14. The position determining system of claim 1, wherein the height of the laser receiver is automatically controlled by the control module to correspond to the height of the laser beam as the work machine moves over a work site.

15. A method for determining the position of a work implement on a work machine relative to a desired grade defined by a laser beam, the work machine having a body and a work linkage, comprising:
detecting the laser beam at a laser receiver;
communicating a height signal based on the laser beam from the laser receiver, the height signal being indicative of a position of the work machine body relative to the laser beam;
pivoting a swing frame of the work linkage in a lateral direction relative to the work machine body about a swing axis;
monitoring the swing position of the swing frame;
communicating a signal indicative of the position of the swing frame;
monitoring a position of a digging arm of the work linkage with at least one digging arm sensor;
communicating a signal indicative of the position of the digging arm; and
determining a position of a portion of the work linkage relative to the desired grade.

16. The method of claim 15, wherein determining the position of the portion of the work linkage includes determining the position of a tip of a work implement relative to the desired grade.

17. The method of claim 15, including:
monitoring the pitch and the roll of the work machine; and
determining the position of the portion of the work linkage relative to the desired grade based on the monitored pitch and roll.

18. The method of claim 15, including pivoting the swing frame and the digging arm about the swing axis with a swing frame actuator.

19. The method of claim 15, including communicating a display signal to a display indicative of the position of the portion of the work linkage.

20. The method of claim 19, including indicating whether the digging arm is above or below the desired grade using a display including a series of lights.

21. The method of claim 20, wherein the lights are LEDs.

22. The method of claim 20, including generating an audible signal that indicates the location of the digging arm relative to the desired grade.

23. The method of claim 15, wherein monitoring the position of the digging arm includes:
monitoring a position of a boom with a boom sensor;
monitoring a position of a stick with a stick sensor; and
monitoring a position of a work implement with a work implement sensor.

24. The method of claim 23, wherein monitoring the position of the digging arm includes monitoring a position of an extendable stick with an E-stick sensor.

25. The method of claim 23, wherein the boom sensor, the stick sensor, and the work implement sensor are position sensors configured to monitor the extension of actuators associated with the boom, the stick, and the work implement.

26. A backhoe, comprising:
a backhoe body;
a work linkage supported by and extending from the backhoe body, the work linkage including a swing frame, a boom, a stick, and a work implement, wherein the swing frame is configured to pivot in a lateral direction relative to the backhoe body about a swing axis, and wherein the boom, the stick, and the work implement are supported by the swing frame;
a swing frame sensor configured to monitor the swing position of the swing frame;
a boom sensor, a stick sensor, and a work implement sensor configured to monitor a position of the boom, the stick, and the work implement, respectively;
a laser receiver disposed on the backhoe body and configured to detect a laser beam, the laser receiver being configured to communicate a height signal indicative of the height of the backhoe body relative to the laser beam; and
a control module in communication with the laser receiver, the swing frame sensor, the boom sensor, the stick sensor, and the work implement sensor, the control module being configured to determine a position of a portion of the work implement relative to the desired grade.

27. The backhoe of claim 26, including an inclinometer disposed on the backhoe to monitor the pitch and the roll of the backhoe, wherein the control module is configured to determine the position of the portion of the work implement relative to the desired grade based on the monitored pitch and roll.

28. The backhoe of claim 26, including a swing frame actuator configured to pivot the work linkage in a lateral direction relative to the backhoe body.

29. The backhoe of claim 26, including a display associated with the control module and configured to convey information regarding the position of the portion of the work implement relative to the desired grade to an operator.

30. The backhoe of claim 26, wherein the display is a light display indicating whether the portion of the work implement is above or below the desired grade.

31. The backhoe of claim 26, wherein the control module is configured to determine the position of a tip of the work implement relative to the desired grade.

32. The backhoe of claim 26, wherein the display includes an audible indicator indicating whether the portion of the work implement is above or below the desired grade.

33. The backhoe of claim 26, wherein the stick is an extendable stick and an E-stick sensor is configured to monitor a position of the extendable stick.
